(19) United States
(12) Patent Application Publication
(10) Pub. No.: US 2008/0238638 A1
(43) Pub. Date: Oct. 2, 2008

(54) Trailer hitch positioning system

(76) Inventor: Tansil Phillips, Halls, TN (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/731,500

(22) Filed: Mar. 30, 2007

(51) Int. Cl. G08B 21/00; B60D 1/36

(52) U.S. Cl. 340/431

(57) ABSTRACT

A system is provided for aligning a vehicle with a trailer. The system includes an angular alignment apparatus and a vertical alignment apparatus. The angular alignment apparatus includes a visible light emitting source and a reference indicia. The vertical alignment apparatus includes a light transmitter and receiver, a reflector and an indicator.

### BACKGROUND OF THE INVENTION

1. Technical Field

This invention pertains to a system for aligning a vehicle with a trailer, and in more particular applications to a system for aligning a vehicle with a trailer using audible and/or visual indicators of proper alignment.

2. Background Art

Vehicles, such as cars and trucks, have been used for many years to haul various types of trailers. For example, vehicles have been used to transport boats, recreational vehicles, animals and other goods on trailers. The design of the respective trailer often varies depending upon the application. For example, trailers are generally connected to the vehicle through either a draw bar or goose-neck type connection. Generally, draw bar connections attach to the rear of the vehicle, oftentimes near the bumper of the vehicle. Goose-neck type trailers generally connect further inward from the bumper, such as to a connection in the bed of a truck. Oftentimes goose-neck connections are used to transport heavy loads and are often found on semi-trailers.

Aligning and connecting a vehicle and a trailer can be a difficult task, especially for novices. This task is made even more difficult when the vehicle driver does not have an additional person to help guide and align the vehicle and trailer. Additionally, the visibility from the vehicle and the type of trailer often further exacerbates the problem as the tow points on each of the vehicle and the trailer cannot be seen by the vehicle driver.

Furthermore, if the vehicle and trailer are not properly aligned when the trailer is lowered to connect to the vehicle, the trailer may be forced to slide to properly align and connect to the vehicle. This sliding action can weaken, bend or even break the legs of the trailer as it is lowered onto the vehicle.

### SUMMARY OF THE INVENTION

In one form, a system for aligning a vehicle with a trailer is provided. The vehicle includes a vertical tow point plane. The trailer includes a vertical tow point plane. The system includes a visible light emitting source and a reference indicia. The visible light emitting source is positioned on the vehicle at a first height along the vehicle vertical tow point plane and directs a visible light along the vehicle tow point plane away from the vehicle. The reference indicia is positioned on the trailer and extends upwardly from a second height to a third height along the trailer vertical tow point plane. The first height is greater than the second height and the visible light strikes the reference indicia when the vehicle and trailer tow point planes are substantially coplanar.

According to one form, a system for aligning a vehicle with a trailer is provided. The vehicle includes a vertical tow point plane with a brake light located along the vehicle tow point plane. The trailer includes vertical tow point plane. The system includes a visible light emitting source and a reference indicia. The visible light emitting source is positioned within the brake light and directs a visible light along the vehicle tow point plane away from the vehicle. The reference indicia is positioned on the trailer extends upwardly along the trailer vertical tow point plane. The visible light strikes the reference indicia when the vehicle and trailer tow point planes are substantially coplanar.

In one form, a system for aligning a vehicle with a trailer is provided. The vehicle includes a tow point and the trailer includes a tow point. The system includes a light transmitter and receiver, a reflector and an indicator. The light transmitter and receiver are located adjacent one of the vehicle tow point and trailer tow point. The reflector is located adjacent the other of the vehicle tow point and trailer tow point. The reflector reflects a light beam from the light transmitter to the receiver when the vehicle is vertically aligned to engage the trailer. The indicator is coupled to the receiver to indicate when the vehicle is vertically aligned to engage the trailer.

According to one form, a system for aligning a vehicle with a trailer is provided. The vehicle includes a tow point and a vertical tow point plane. The trailer includes a tow point and a vertical tow point plane. The system includes an angular alignment apparatus and a vertical alignment apparatus. The angular alignment apparatus includes a visible light emitting source and a reference indicia. The visible light emitting source is located on the vehicle and directs a visible light along the vehicle vertical tow point plane away from the vehicle. The reference indicia is positioned on the trailer and extends upwardly along the trailer vertical tow point plane. The visible light strikes the reference indicia when the vehicle and trailer tow point planes are substantially coplanar. The vertical alignment apparatus includes a light transmitter and receiver, a reflector and an indicator. The light transmitter and receiver is located adjacent one of the vehicle tow point and trailer tow point. The reflector is located adjacent the other of the vehicle tow point and trailer tow point. The reflector reflects a light beam from the light transmitter to the receiver when the vehicle is vertically aligned to engage the trailer. The indicator is coupled to the receiver to indicate when the vehicle is vertically aligned to engage the trailer.

In one form, the visible light emitting source is a laser.

According to one form, the visible light emitting source is positioned in a third brake light of the vehicle.

In one form, the visible light emitting source is positioned in an external housing located on the vehicle.

In accordance with one form, the vehicle includes an electrical system and the visible light emitting source is independent of the vehicle electrical system.

According to one form, the visible light emitting source is positioned to direct the visible light downwardly from the first height.

In accordance with one form, the visible light emitting source is horizontally and vertically adjustable when positioned on the vehicle.

According to one form, the reflector is circular.

In accordance with one form, the reflector is crescent shaped.

According to one form, the indicator emits a sound indication.

In accordance with one form, the indicator emits a visible light indication.

According to one form, transmitter and receiver are located on the trailer.

Other objects, features, and advantages of the invention will become apparent from a review of the entire specification, including the appended claims and drawings.

### BRIEF DESCRIPTION OF THE DRAWINGS

FIG. 1 is a side view of a vehicle with an attached trailer;

FIG. 2 is a partial side view of a vehicle and trailer including a system for aligning the vehicle with a trailer;

FIG. 3 is a disassembled view of one embodiment of a visible light emitting source;

FIG. 4 is a front view of the visible light emitting source located within a brake light of a vehicle;

FIG. 5 is an enlarged view of the visible light emitting source of FIG. 4;

FIG. 6A is a front view of a reference indicia positioned on a trailer;

FIG. 6B is a front view of a reference indicia positioned on an alternative form of trailer;

FIG. 7 is a side view of a further system for aligning a vehicle with a trailer;

FIG. 8 is a top view of a hitch and one embodiment of a reflector; and

FIG. 9 is a top view of a hitch and a further embodiment of a reflector.

### DETAILED DESCRIPTION OF THE PREFERRED EMBODIMENT

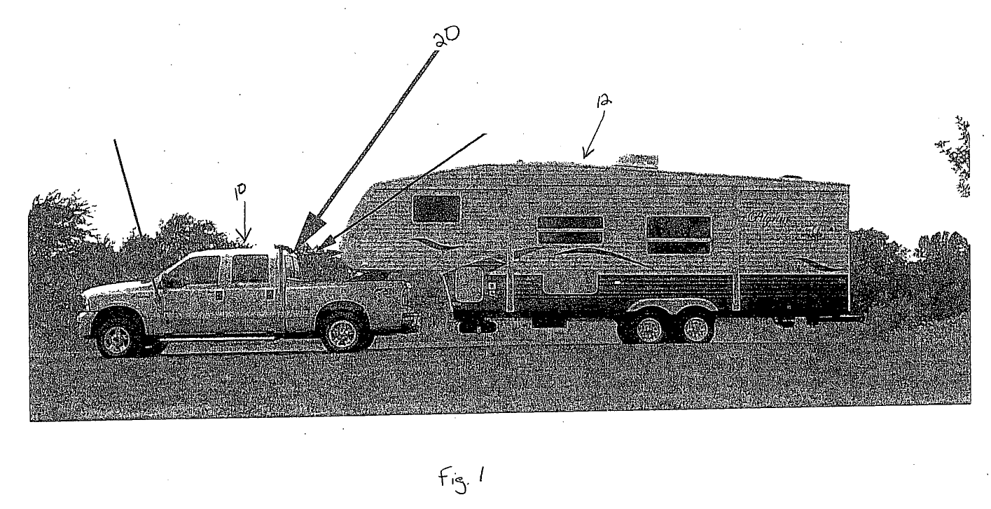

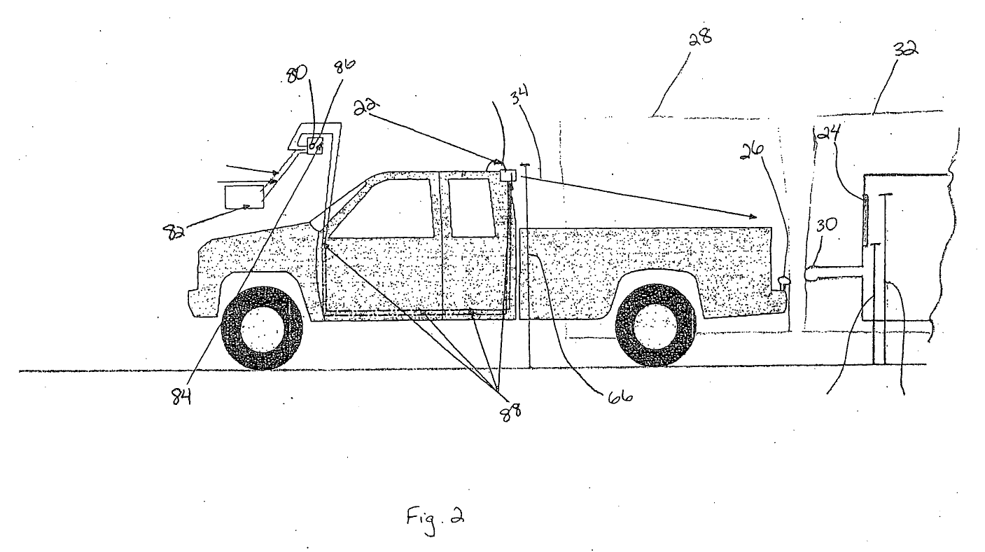

Referring to FIG. 1, a vehicle 10 and a trailer 12 are aligned and connected to one another. The vehicle 10 and the trailer 12 include a system 20 for aligning the vehicle 10 with the trailer 12. Specifically, referring to FIG. 2, the system 20 includes the vehicle 10 having a visible light emitting source 22 and the trailer 12 having a reference indicia 24. The vehicle 10 also includes a tow point 26 and a vehicle vertical tow point plane 28 which includes the tow point 26 and, in most instances, bisects the vehicle 10. The trailer 12 also includes a tow point 30 and a trailer vertical tow point plane 32 which includes the tow point 28 and, in most instances, bisects the trailer 12. The system 20 generally functions as an angular alignment apparatus as described below.

The visible light emitting source 22 directs a visible light, as illustrated by arrow 34, along the vehicle tow point plane 28 and away from the vehicle 10. The visible light emitting source 22 may take various forms. For example, in one form, the visible light emitting source 22 is a laser. In another form, the visible light emitting source 22 is a focused light bulb. Other forms of visible light emitting sources 22 are also contemplated, as understood by those skilled in the art.

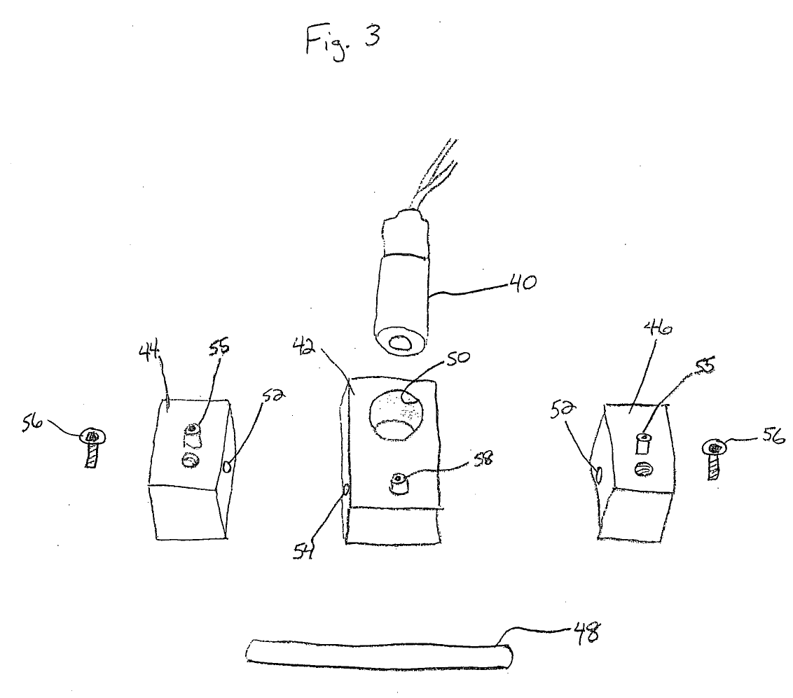

Referring to FIG. 3, one form of a visible light emitting source 22 is shown. This embodiment includes a laser 40, an adjusting member 42, retaining members 44,46 and a shaft 48. The laser 40 is secured within an opening 50 in the adjusting member 42. The shaft 48 extends between the retaining members 44,46, via openings 52 and through the adjustment member 42, via passageway 54. Suitable fasteners, such as screws 55 can be used to secure the retaining members 44,46 to the shaft 48. Screws 56 can be used to secure the visible light emitting source 22 to a suitable housing. Additionally, a screw 58 can be used to adjustably secure the adjusting member 42 to the shaft. The adjusting member 42 can be used to adjust the laser 40 side to side as well as up and down to provide the desired direction of visible light 34.

The visible light emitting source 22 may be positioned within a variety of housings. For example, as illustrated in FIG. 2, the visible light emitting source 22 is positioned within an external housing or dome 60. This form of external housing can be easily removed from the vehicle 10 when not in use and/or secured permanently to the vehicle 10.

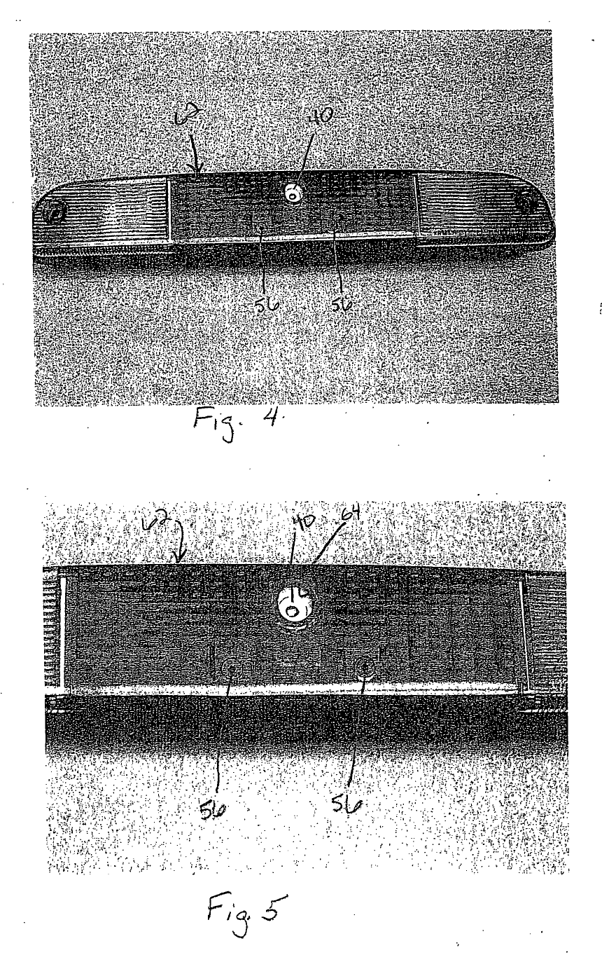

Another form of housing is shown in FIGS. 4-5. As seen in these figures, the visible light emitting source 22 is positioned within a brake light 62, such as the third brake light of the vehicle 10. In this embodiment, the brake light 62 includes an opening 64 to permit the visible light 34 to pass out of the brake light 62. However, it should be understood that a cover may be placed over the opening 64 and still permit the visible light to pass out of the brake light 62. The brake light 62 is gasketed as understood by those skilled in the art to prevent moisture and other debris from entering the brake light 62.

Referring to FIG. 2, the visible light emitting source 22 is positioned on the vehicle 10 at a first height, represented by line 66. As illustrated in this embodiment, the visible light emitting source 22 directs the visible light 34 downwardly to minimize potential danger to drivers behind the vehicle 10, should the light emitting source 22 be left on while driving. However, it should be understood by those skilled in the art that the light emitting source may also direct the visible light 34 upwardly or horizontally as desired.

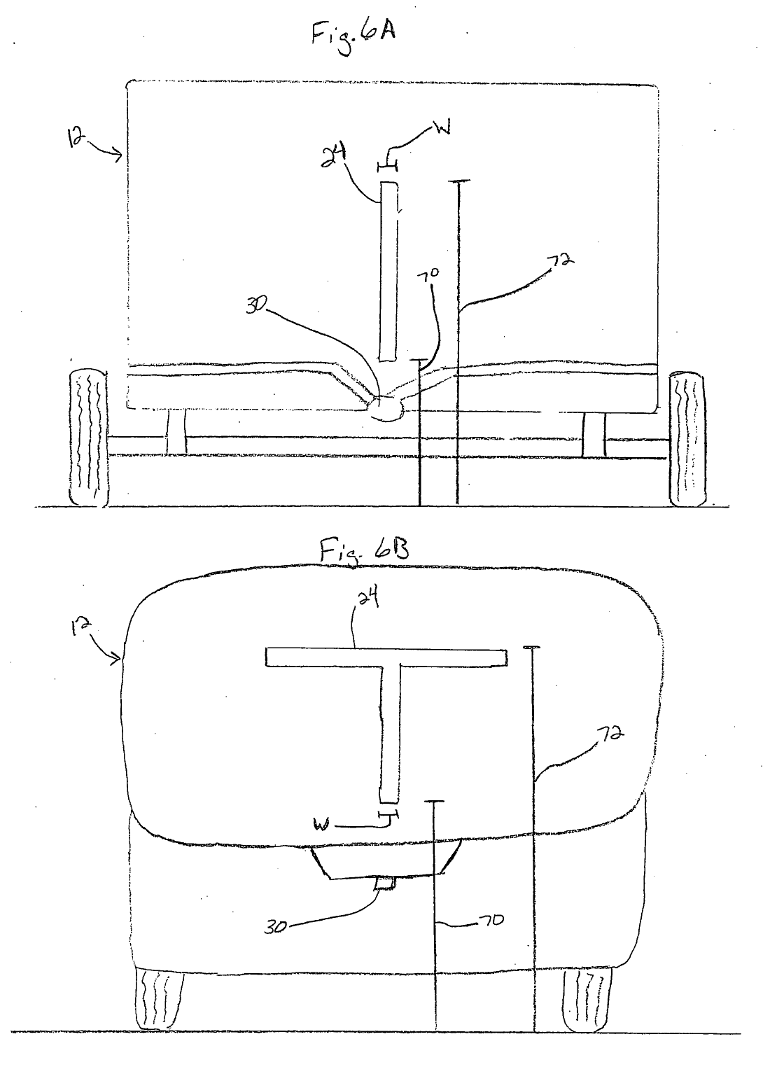

One embodiment of the reference indicia 24 is illustrated in FIG. 6A as affixed to one form of a trailer 12. As seen in this figure, the reference indicia 24 is aligned with the tow point 30 and extends between upwardly from a second height, illustrated by line 70, to a third height, illustrated by line 72, along the trailer vertical tow point plane 32. In a preferred embodiment, the reference indicia 24 should be vertically located so that at least a portion of the reference indicia 24 is visible by the driver of the vehicle 10 when the vehicle 10 is being aligned with the trailer 12. As seen in FIG. 6A, the reference indicia 24 is a vertical line. Other shapes are also contemplated. For example, referring to FIG. 6B, the reference indicia 24 is in the form of the letter “T”. However, it should be understood that the reference indicia 24 may take other forms, such as other letters, numbers and shapes. Furthermore, as seen in FIG. 6B, the reference indicia 24 can be used on a variety of trailers, such as a goose-neck trailer.

In a preferred form, the reference indicia 24 has a relatively narrow width, such as width W in FIGS. 6A-B. Preferably, the width W should not be too large, but should provide for a small margin of error such that when the visible light 34 strikes the reference indicia 24, the vehicle and trailer vertical tow planes 28,32 are substantially coplanar. In one form, the width W of the reference indicia 24 is approximately the same size as the tow point 30. It should be understood that the width W may also be smaller or larger than the tow point 30 depending upon the size of the tow point 30 and the preferred margin of error.

In one form, the reference indicia 24 is made from a weather-resistant plastic material. However, it should be understood that the reference indicia 24 may be made from a variety of materials. In one form, the reference indicia 24 has an adhesive backing to attach to the trailer 12. The reference indicia 24 may also be made in a variety of colors. Furthermore, the reference indicia 24 may be colored so as to be of a contrasting color compared to the color of the trailer 12 to further enhance the driver's ability to see the visible light 34 when it strikes the reference indicia 24.

The system 20 may also include a control box 80 to control and/or power the visible light emitting source 22, such as illustrated in FIG. 2. This control box 80 may be located in the vehicle 10 (it is illustrated outside of the vehicle 10 to more easily depict the components). The control box 80 includes a power source 82, which may be located either internally or externally, a power switch 84 and an indicator 86. The switch 84 is used to turn the visible light emitting source 24 on and off while the indicator 86 provides a visual and/or audible indication when the visible light emitting source 24 is on. The control box 80 is connected to the visible light emitting source 24 via wires 88. In one form, the system 20, including control box 80, is completely independent of the vehicle's electrical system. However, it is also contemplated that the system 20 may be integrated into the vehicle's electrical system.

The operation of the system 20 will now be described in more detail. The driver of the vehicle 10 must first turn the system on, such as through power switch 84. As the vehicle 10 approaches the trailer 12, the visible light 34 will strike the reference indicia 24 when the vehicle and trailer vertical tow point planes 28,32 are coplanar. Therefore, the visible light 34 can be used by an driver to align the vehicle 10 with the trailer 12. Specifically, the driver can manipulate the vehicle 10 and/or trailer 12 by moving the respective component side to side until the visible light 34 strikes the reference indicia 24. Once the visible light 34 strikes the reference indicia 24, the vehicle 10 and trailer are properly aligned and can be brought together and connected while maintaining the visible light on the reference indicia 24.

In one embodiment where the visible light 34 is directed downwardly, the driver of the vehicle 10 can use the movement of the visible light 34 relative to the reference indicia 24 to help determine the proximity of the vehicle 10 to the trailer 12. Specifically, when angled downwardly, the visible light 34 will start towards the bottom of the reference indicia 24 and move upwardly as the vehicle 10 and the trailer 12 approach one another. For example, referring to FIG. 6B, the visible light 34 may move upwardly and reach the top of the “T” when the vehicle 10 and the trailer 12 are sufficiently close that they can be connected. Therefore, the visible light 34 and reference indicia 24 may also be used to determine proximity of the vehicle 10 and the trailer 12.

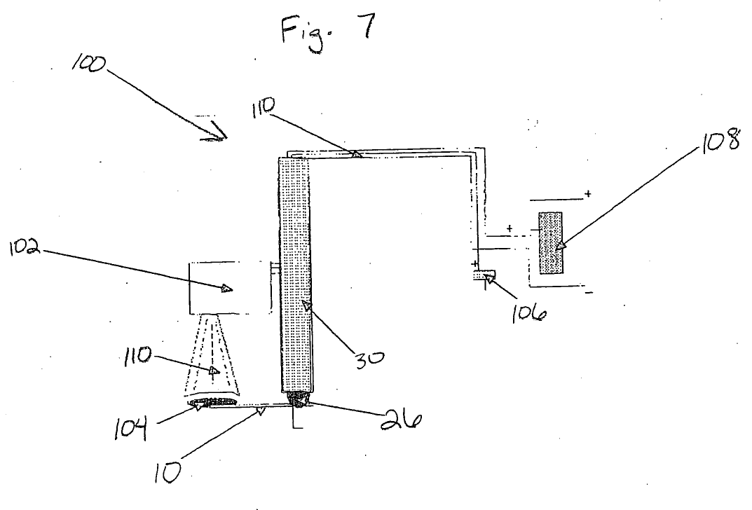

A further system 100 may also be used to align the vehicle 10 with the trailer 12. This system 100 may be used by itself or in combination with the system 20. Referring to FIG. 7, one embodiment of the system 100 is illustrated. The system 100 includes a light transmitter and receiver, such as integrated transceiver 102, a reflector 104 and an indicator 106. The system 100 may also include a control box 108. The system 100 generally functions as a vertical alignment apparatus as described below.

As shown in FIG. 7, the transmitter and receiver are depicted as a single unit, transceiver 102. It should be understood by those skilled in the art that the transmitter and receiver may also exist as two separate units. Additionally, as illustrated in FIG. 7, the transceiver 102 is located on the tow point 30 on the trailer 12. It should be understood that the transceiver 102 may instead be located on the vehicle 10. The transceiver 102 can be any conventional transceiver as understood by those skilled in the art. For example, the transceiver may emit signal 110, such as a visible beam of light and/or an invisible beam. The transceiver 102 is connected to the control box 108 and indicator 106 via wires 110.

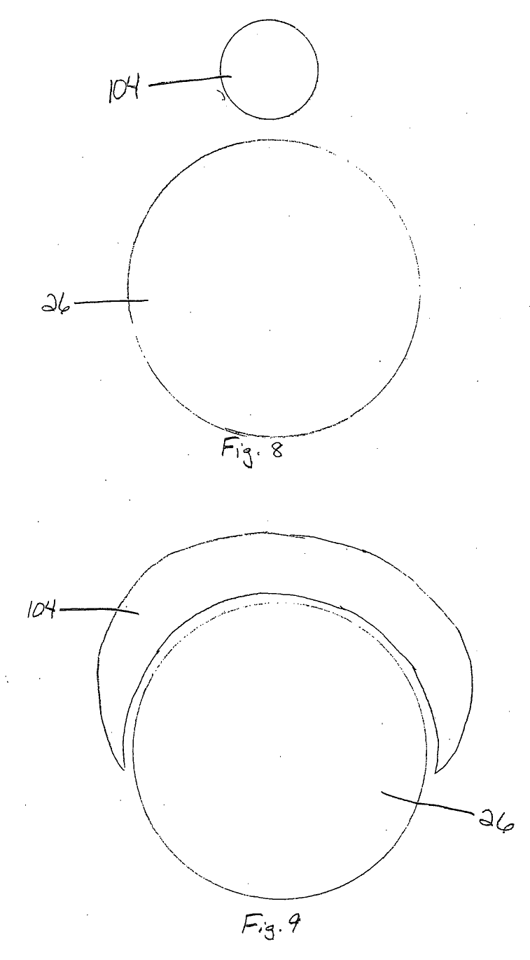

The reflector 104 may take a variety of forms, such as illustrated in FIG. 7-9. As illustrated in FIG. 8, the reflector 104 has a small circular shape and is located adjacent the tow point 26. As illustrated in FIG. 9, the reflector 104 has a crescent shape and is located adjacent the tow point 26. The reflector 104 may be located adjacent the tow point 26, as illustrated in the figures, or located adjacent the tow point 30 on the trailer 12 when the transceiver 102 is located on the vehicle 10. The reflector 104 may take conventional forms, as understood by those skilled in the art, to adequately reflect the signal 110 back to the transceiver 102.

The indicator 106 and control box 108 may be incorporated into a single unit or may be separated. The indicator 106 may be a visible indicator, such as a light, an audible indicator which may be a sound such as an alarm or other indicator understood by those skilled in the art. Furthermore, the control box 108 may be similar to the control box 80 described above. Additionally, the control box 108 may be incorporated into the control box 80 and installed within the vehicle 10, along with the indicator 106.

The system 100 is operated similarly to the system 20 described above. The driver or operator will turn the system on via the control box 108, thereby activating the transceiver 102. Initially, the transceiver 102 transmits the signal 110, but does not receive the signal 110 back because the reflector 104 is not aligned with the transceiver 102. As the vehicle 10 and trailer are brought together, the transceiver 102 may be aligned vertically with the reflector 104 whereby the signal 110 is reflected back by the reflector 104 to the transceiver 102. Once this occurs, a signal will be sent from the transceiver 102 to the indicator 104, thereby indicating to the driver or operator that the vehicle 10 and trailer 12 are vertically aligned.

As described above, the systems 20 and 100 may be used together as a single system or in conjunction as two independent systems and may be controlled from a single location or from multiple locations. Generally, the system 20 acts as an angular alignment apparatus whereby the driver can properly align the vehicle 10 with the trailer 12 as the two components are brought together. The driver can maintain the vehicle 10 and trailer 12 in alignment using the system 20 and further utilize the system 100 to determine when the tow points 26,30 are vertically aligned. Therefore, when used in combination, the systems 20 and 100 can allow a driver to properly align the vehicle 10 and trailer 12 in a single operation without having to interrupt the process to visually inspect the locations of the tow points 26,30 relative to one another.

It should be appreciated that for all of the disclosed embodiments there are many possible modifications. Additionally, it should be understood that the embodiments described herein may be utilized with a variety of different vehicles and trailers.

1. A system for aligning a vehicle with a trailer, the vehicle having a vertical tow point plane and the trailer having a vertical tow point plane, the system comprising:
a visible light emitting source positioned on the vehicle at a first height along the vehicle vertical tow point plane and directing a visible light along the vehicle tow point plane away from the vehicle; and,
a reference indicia positioned on the trailer extending upwardly from a second height to a third height along the trailer vertical tow point plane,
wherein the first height is greater than the second height and the visible light strikes the reference indicia when the vehicle and trailer tow point planes are substantially coplanar.

2. The system of claim 1 wherein the visible light emitting source is a laser.

3. The system of claim 1 wherein the visible light emitting source is positioned in a third brake light of the vehicle.

4. The system of claim 1 wherein the visible light emitting source is positioned in an external housing located on the vehicle.

5. The system of claim 1 wherein the vehicle includes an electrical system and the visible light emitting source is independent of the vehicle electrical system.

6. The system of claim 1 wherein the visible light emitting source is positioned to direct the visible light downwardly from the first height.

7. The system of claim 1 wherein the visible light emitting source is horizontally and vertically adjustable when positioned on the vehicle.

8. A system for aligning a vehicle with a trailer, the vehicle having a vertical tow point plane with a brake light located along the vehicle tow point plane and the trailer having a vertical tow point plane, the system comprising:
a visible light emitting source positioned within the brake light and directing a visible light along the vehicle vertical tow point plane away from the vehicle; and,
a reference indicia positioned on the trailer extending upwardly along the trailer vertical tow point plane,
wherein the visible light strikes the reference indicia when the vehicle and trailer tow point planes are substantially coplanar.

9. The system of claim 8 wherein the visible light emitting source is a laser.

10. The system of claim 8 wherein the visible light emitting source is positioned in an external housing located on the vehicle.

11. The system of claim 8 wherein the vehicle includes an electrical system and the visible light emitting source is independent of the vehicle electrical system.

12. The system of claim 8 wherein the visible light emitting source is positioned to direct the visible light downwardly from the first height.

13. The system of claim 8 wherein the visible light-emitting source is horizontally and vertically adjustable when positioned on the vehicle.

14. A system for aligning a vehicle with a trailer, the vehicle having a tow point and the trailer having a tow point, the system comprising:
a light transmitter and receiver located adjacent one of the vehicle tow point and trailer tow point;
a reflector located adjacent the other of the vehicle tow point and trailer tow point, wherein the reflector reflects a light beam from the light transmitter to the receiver when the vehicle is vertically aligned to engage the trailer; and,
an indicator coupled to the receiver to indicate when the vehicle is vertically aligned to engage the trailer.

15. The system of claim 14 wherein the reflector is circular.

16. The system of claim 14 wherein the reflector is crescent shaped.

17. The system of claim 14 wherein the indicator emits a sound indication.

18. The system of claim 14 wherein the indicator emits a visible light indication.

19. The system of claim 14 wherein transmitter and receiver are located on the trailer.

20. A system for aligning a vehicle with a trailer, the vehicle having a tow point and a vertical tow point plane, the trailer having a tow point and a vertical tow point plane, the system comprising:
an angular alignment apparatus including a visible light emitting source located on the vehicle directing a visible light along the vehicle vertical tow point plane away from the vehicle, and a reference indicia positioned on the trailer extending upwardly along the trailer vertical tow point plane wherein the visible light strikes the reference indicia when the vehicle and trailer tow point planes are substantially coplanar; and,
a vertical alignment apparatus including a light transmitter and receiver located adjacent one of the vehicle tow point and trailer tow point, a reflector located adjacent the other of the vehicle tow point and trailer tow point wherein the reflector reflects a light beam from the light transmitter to the receiver when the vehicle is vertically aligned to engage the trailer, and an indicator coupled to the receiver to indicate when the vehicle is vertically aligned to engage the trailer.

21. The system of claim 20 wherein the visible light emitting source is a laser.

22. The system of claim 20 wherein the visible light emitting source is positioned in a third brake light of the vehicle.

23. The system of claim 20 wherein the visible light emitting source is positioned in an external housing located on the vehicle.

24. The system of claim 20 wherein the vehicle includes an electrical system and the visible light emitting source is independent of the vehicle electrical system.

25. The system of claim 20 wherein the visible light emitting source is positioned to direct the visible light downwardly from the first height.

26. The system of claim 20 wherein the visible light emitting source is horizontally and vertically adjustable when positioned on the vehicle.

27. The system of claim 20 wherein the reflector is circular.

28. The system of claim 20 wherein the reflector is crescent shaped.

29. The system of claim 20 wherein the indicator emits a sound indication.

30. The system of claim 20 wherein the indicator emits a visible light indication.

31. The system of claim 20 wherein transmitter and receiver are located on the trailer.
